(19) United States
(12) Patent Application Publication
(10) Pub. No.: US 2018/0281134 A1
(43) Pub. Date: Oct. 4, 2018

(54) Method for Redistributing Residual Stress in an Engine Component

(71) Applicant: General Electric Company, Schenectady, NY (US)

(72) Inventors: Robert Allen Hagan, Reading, MA (US); James William Culley, North Falmouth, MA (US); Joan Elizabeth Bissett, Salem, MA (US); Rebecca Dawn Finlay, Loveland, OH (US); Donald Charles Slavik, Cincinnati, OH (US)

(21) Appl. No.: 15/471,814

(22) Filed: Mar. 28, 2017

(51) Int. Cl. B23P 25/00; B21K 3/00; B23P 15/00

(52) U.S. Cl. CPC B23P 25/00; F01D 5/02; B23P 15/006; B21K 3/00

(57) ABSTRACT

A method for redistributing an area of residual stress around a machined central aperture in an engine component. The method includes changing tensile stress to compressive stress at an area circumscribing the machined aperture. The method can be applied to, for example, a forged engine component such as a rotating disk or an impeller part for a gas turbine engine.

### BACKGROUND OF THE INVENTION

Turbine engines, and particularly gas or combustion turbine engines, are rotary engines that extract energy from a flow of combusted gases passing through the engine onto a multitude of rotating turbine blades.

Gas turbine engines can include engine components machined from forged pieces or components machined from pieces produced by other manufacturing processes, i.e. casting. These manufacturing processes include bringing the raw material to a piece that resembles the finished piece but still requires machining. An engine component can include a central hole, or aperture, often termed the bore of the part. In some applications, the bore area of a rotating disk is subjected to exceptionally high stresses.

Due to the forging and heat treat processes involved with manufacturing an engine component, the bore residual stresses may be highly tensile. The engine component can become low cycle fatigue limited, and since the bore stresses exceed yield stress limits for the disk material permanent, plastic deformation can occur after engine operation, perhaps even during the first cycle. Methods have been established to address these two considerations independently. It is advantageous to address both considerations simultaneously.

### BRIEF DESCRIPTION OF THE INVENTION

An aspect of the present disclosure relates to a method for redistributing a residual stress about a central aperture of a pre-machined engine component, the method comprising changing tensile stress to compressive stress in the pre-machined engine component by applying cold expansion to the central aperture of the pre-machined engine component.

In another aspect, the present disclosure relates to a method for redistributing an area of residual stress in a forged rotating disk prior to completing a final machining, the method comprising changing tensile stress to compressive stress in the forged impeller by applying cold expansion to the center of the forged rotating disk.

### BRIEF DESCRIPTION OF THE DRAWINGS

In the drawings:

FIG. 1 is a schematic cross-sectional diagram of a gas turbine engine for an aircraft.

FIG. 2 is a cross-section view of a forged engine component for the gas turbine engine of FIG. 1

FIG. 3A is a portion of the cross-section view of FIG. 2 with a tapered mandrel positioned to be inserted into an aperture of the forged engine component.

FIG. 3B is a portion of the cross-section view of FIG. 2 with the tapered mandrel in the aperture of the forged engine component.

FIG. 3C is a portion of the cross-section view of FIG. 2 with the tapered mandrel and a sleeve within the aperture of the forged engine component.

FIG. 4 is a portion of the forged engine component of FIG. 2 after the tapered mandrel is removed.

FIG. 5 is a cross-section view of a finished impeller from the forged engine component of FIG. 4.

FIG. 6 is a perspective view of the finished impeller of FIG. 5.

### DETAILED DESCRIPTION OF THE INVENTION

Aspects of the disclosure described herein are directed to a method for redistributing residual stress in an engine component. For purposes of illustration, the present disclosure will be described with respect to an impeller of an aircraft gas turbine engine where the impeller is machined from a forging. It will be understood, however, that aspects of the disclosure described herein are not so limited and may have general applicability within an engine, including other rotating disks or static components with central apertures, as well as in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

Additionally, as used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

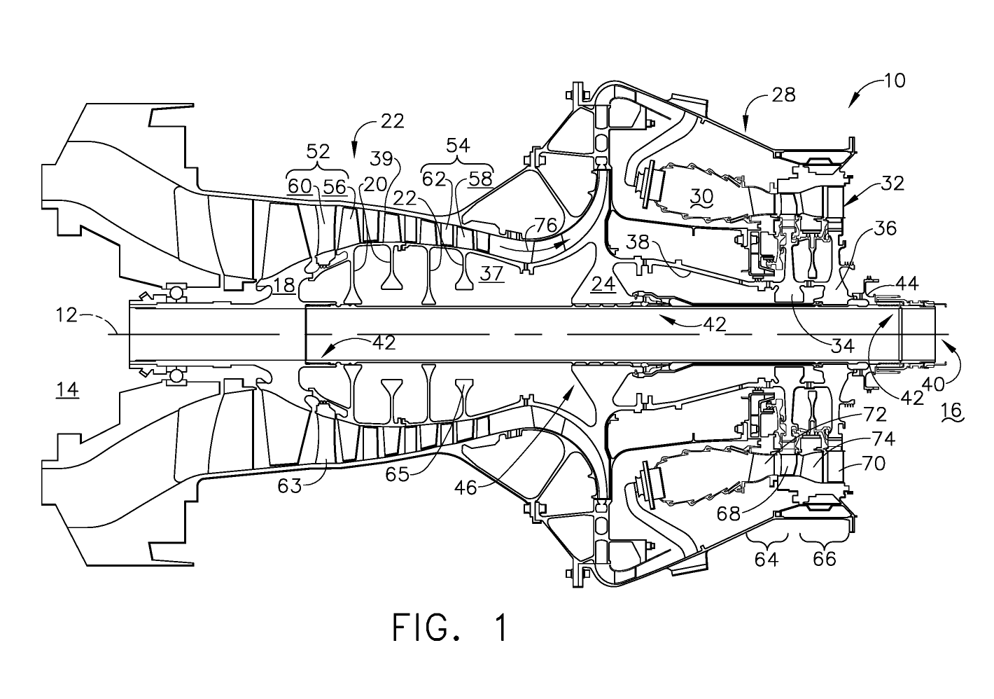

FIG. 1 is a schematic cross-sectional diagram of a gas turbine engine 10 for an aircraft. The engine 10 has a generally longitudinally extending axis or centerline 12 extending forward 14 to aft 16. The engine 10 includes, in downstream serial flow relationship, a compressor section 22 including a blisk 18, at least two stage spools 20, 22 and an impeller 24, a combustion section 28 including a combustor 30, and a turbine section 32 including at least two stage disks 34, 36. An engine core 37 is surrounded by a core casing 39.

An impeller shaft 38 is disposed coaxially about the centerline 12 of the engine 10 drivingly connecting the compressor section 22 to the turbine section 32, by way of non-limiting example connecting the impeller 24 to the disk 34.

The impeller shaft 38 is rotatable about the engine centerline and couples to a plurality of rotatable elements. A tie rod 40 provides a compressive load path, by way of non-limiting example through couplings 42, for all rotatable elements extending forward 14 to aft 16 throughout the engine. Together the impeller shaft 38, tie rod 40, a turbine rear shaft 44 and other rotatable elements collectively define a rotor 46.

The compressor section 22 includes a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to spools 20, 22, with each stage having its own disk 65. The vanes 60, 62 for a stage of the compressor can be mounted to the core casing 39 in a circumferential arrangement.

The turbine section 32 includes a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to disks 34, 36. The vanes 72, 74 for a stage of the turbine section 32 can be mounted to the core casing 39 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow received at the blisk 18 is channeled into the LP compressor section 22, which then supplies pressurized air 76 to the impeller 24, which further pressurizes the air. The pressurized air 76 from the impeller 24 is mixed with fuel in the combustor 30 and ignited, thereby generating combustion gases. Some work is extracted from these gases by the turbine section 32, which drives the compressor section 22. Exhaust gas is ultimately discharged from the engine 10 via an exhaust section (not shown).

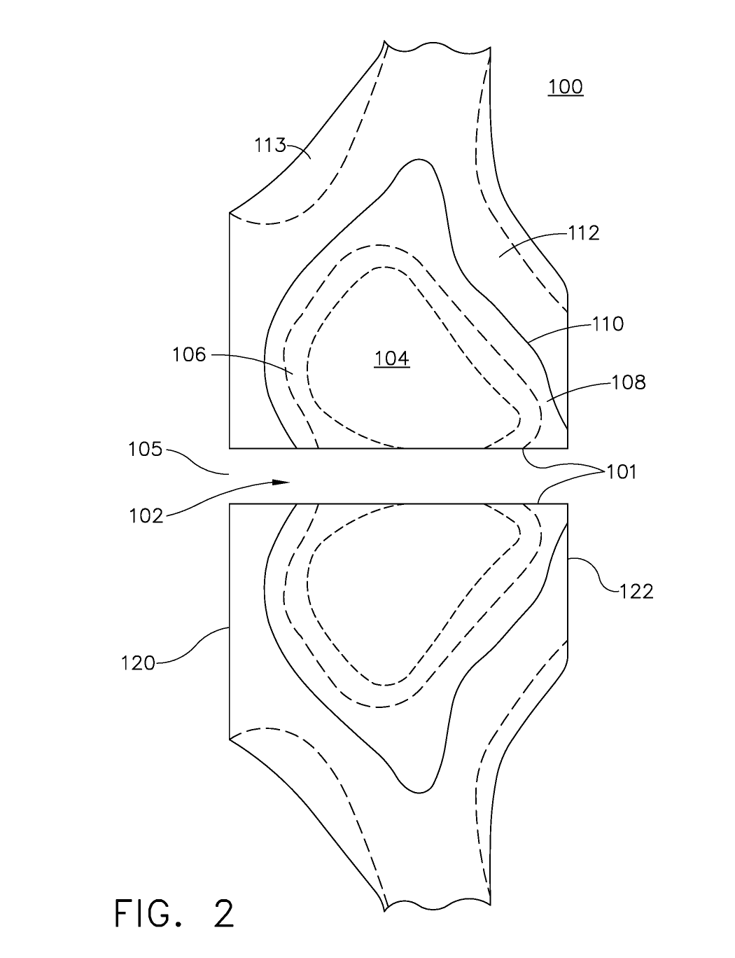

FIG. 2 depicts a cross-section of an engine component, by way of non-limiting example a forged impeller 100. It should be understood that the engine component is not limited to a forged impeller and can be any engine component processed before complete machining of the engine component such as, but not limited to any rotating disk. The forged impeller 100 will be finalized for installation within the engine 10 as the impeller 24, hence the substantially impeller shape. The forged impeller 100 includes a central aperture 102 at a center 105 of the forged impeller 100. The central aperture 102 can be machined into the forged impeller 100 such that the central aperture 102 is defined by a bore surface 101 and runs through from a first side 120 of the forged impeller 100 to a second side 122 of the forged impeller 100. The aperture can have, but is not limited to, a diameter of less than 3 inches (8 cm), and preferably less than 2 inches (5 cm).

The illustrated cross-section includes different areas of residual stress 104, 106, 108, 112, 113 within the forged impeller 100. A forging heat treating process strengthens the forged impeller 100 leaving these areas of residual stress 104, 106, 108, 112, 113 throughout the forged impeller 100. The resulting forged impeller 100 includes interior areas of progressively smaller annular areas of tensile stress 104, 106, 108 proximate to and in contact with the bore surface 101 of the central aperture 102. A solid line 110 represents a border between areas of tensile stress 104, 106, 108 and areas of compressive stress 112, 113. It should be understood that the distribution and relative location of the different areas of residual stress 104, 106, 108, 112, 113 with respect to each other is illustrated for exemplary purposes only and that more or less areas can be contemplated each with differing scopes and sizes.

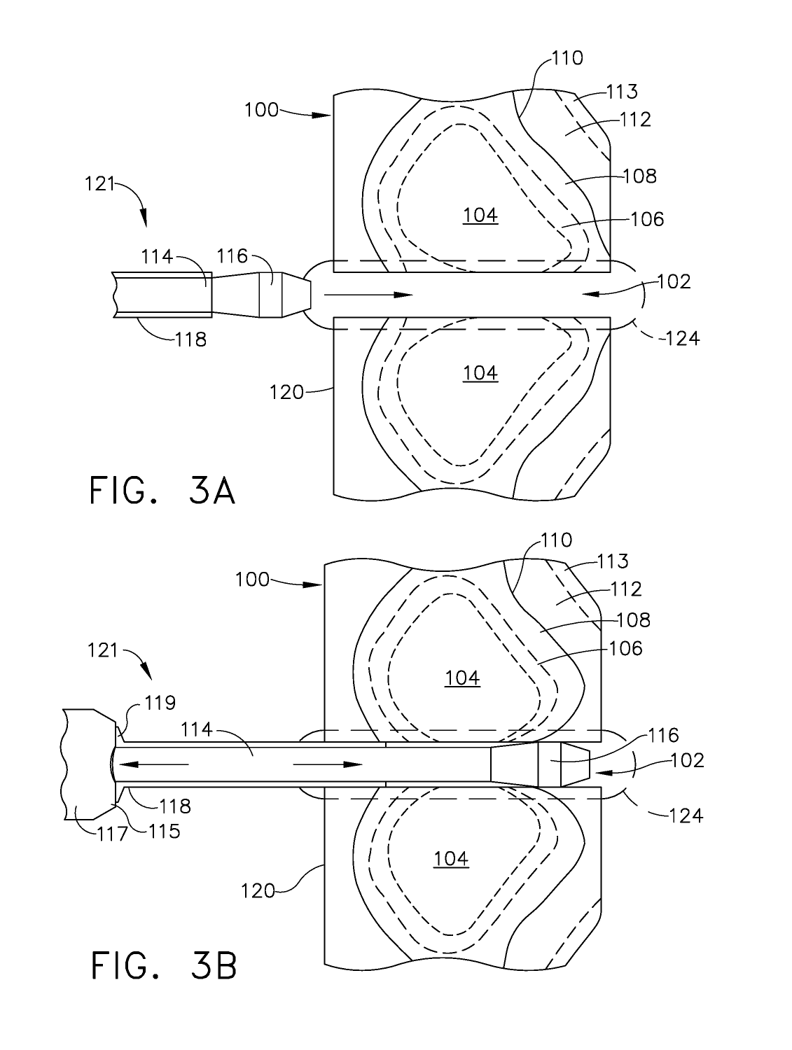

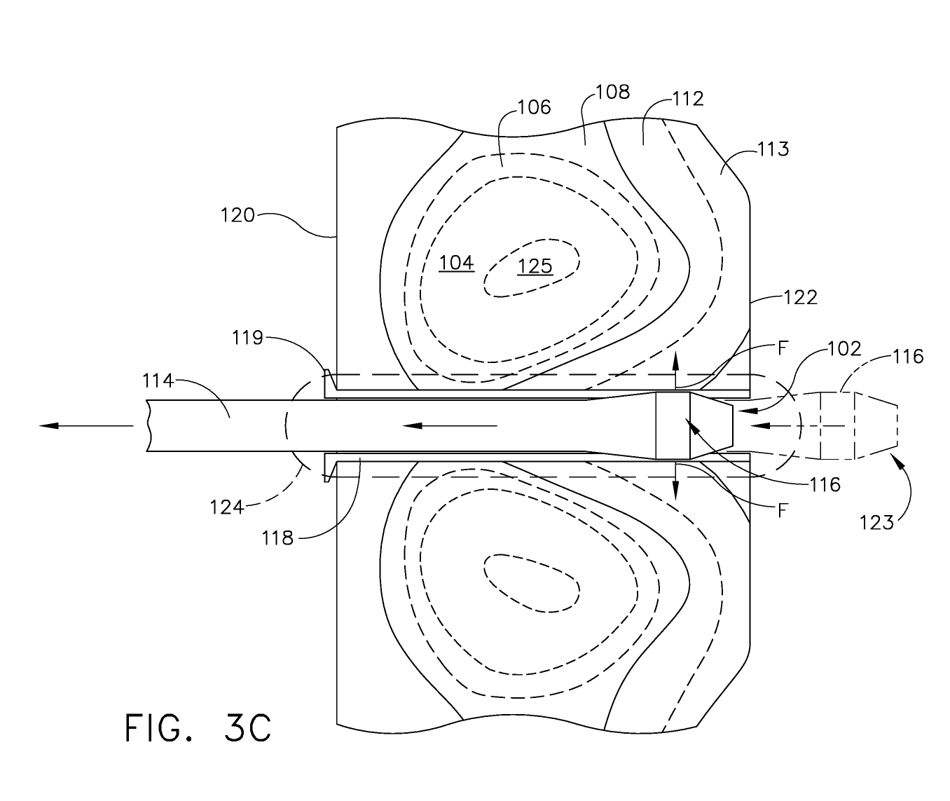

Turning to FIG. 3A, a portion of the cross-section of the forged impeller 100 is illustrated. An area 124 local to the central aperture 102, encompasses all portions of the forged impeller 100 proximate to and circumscribing the central aperture 102. A tapered mandrel 114 is located proximate the first side 120 of the impeller in a first position 121. A maximum diameter portion 116 defines one end of the tapered mandrel 114. A lubricated split sleeve 118 envelops the tapered mandrel 114 at a location such that when inserted, the lubricated split sleeve 118 follows after the maximum diameter portion 116 of the tapered mandrel 114.

A method for redistributing the areas of residual stress 104, 106, 108, 112, 113 about the central aperture 102 of the forged impeller 100 includes applying cold expansion, which can include but is not limited to split sleeve cold expansion to the central aperture 102. Split sleeve cold expansion is one cold expansion method that changes tensile stress 104, 106, 108 in the local area 124 to compressive stress.

FIG. 3B depicts a beginning of the process of split sleeve cold expansion with insertion of the maximum diameter portion 116 of the tapered mandrel 114 into the central aperture 102 from the first side 120 of the forged impeller 100. The tapered mandrel 114 is pushed into the central aperture 102 causing the lubricated split sleeve 118 to follow until abutting the first side 120. When the lubricated split sleeve 118 abuts both the first side 120 and an end 115 of a mandrel puller tool 117 is forced to slide into the central aperture 102 around the tapered mandrel 114. In the illustrated example, the lubricated split sleeve 118 has begun to slide into the central aperture 102.

Turning to FIG. 3C the lubricated split sleeve 118 remains within the central aperture 102 upon insertion into the first side 120 and is held in place with insertion ends 119. The tapered mandrel 114 continues through the entire central aperture 102 until the maximum diameter portion 116 reaches a second position 123, shown in phantom, where the maximum diameter portion 116 has exited a second side 122 of the forged impeller. Upon placement of the lubricated split sleeve 118, the tapered mandrel 114 is pulled back through the central aperture 102 from the second side 122 towards the first side 120. As the maximum diameter portion 116 moves back through the central aperture 102, a pushing force F is applied to the bore surface 101 by the maximum diameter portion 116 of the central aperture 102 causing the areas of residual stress 104, 106, 108, 112, 113 in the forged impeller 100 to redistribute. It is contemplated that during the expansion process, residual stresses are redistributed such that the highly compressive residual stress 113 can be offset by an area of relatively high tensile stress 125 beginning to form outside the local area 124. The split sleeve cold expansion process is applied to the central aperture 102 only, resulting in a local tensile stress area 125 of relatively smaller magnitude and size when compared to alternative methods such as a pre-spin treatment.

It should be understood that aspects of the disclosure described herein are not limited to split sleeve cold expansion and can have applicability to other methods of cold expansion.

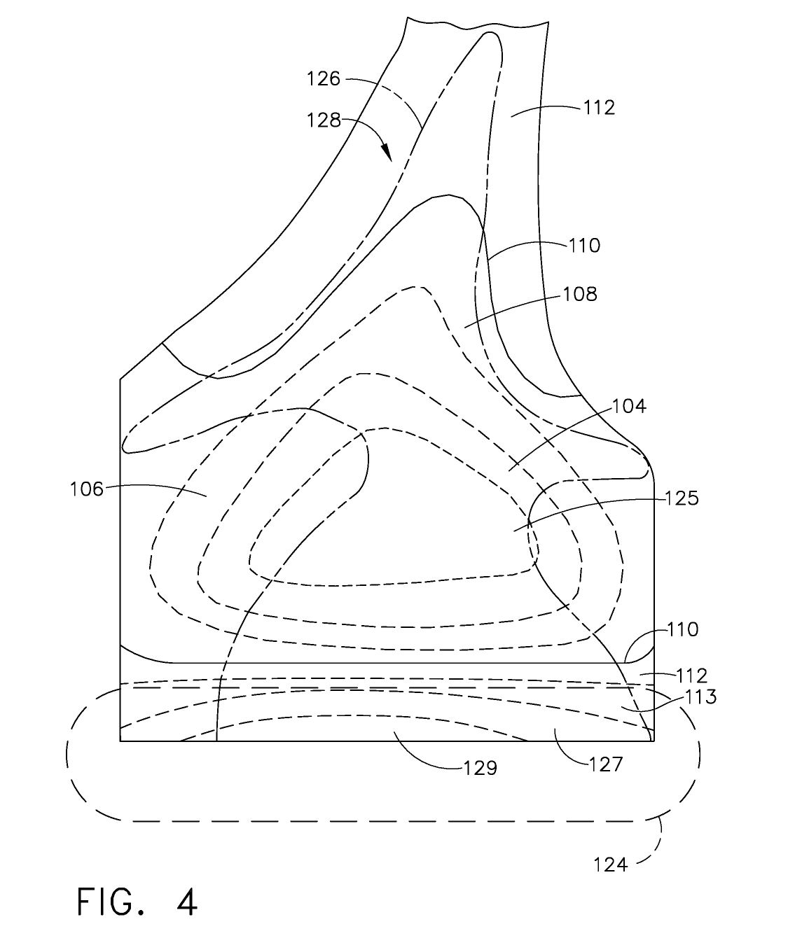

Turning to FIG. 4, a portion of the forged impeller 100 is illustrated after the split sleeve cold expansion is complete. The areas of tensile stress 104, 106, 108, 125 have been completely redistributed from the local area 124 and replaced with areas of compressive stress 112, 113, 127, 129. A final impeller shape 126 is illustrated in phantom. Excess portions 128 of the forged impeller 100 outside the final impeller shape 126 are removed to form the final engine component which in the illustrated example is the impeller 24. Removal of the excess portions 128 can be done through machining, by way of non-limiting example using subtractive manufacturing through turning operations or milling operations. CNC machining, electrical discharge machining, electro-chemical erosion, laser cutting, or water jet cutting, are all non-limiting examples of machining processes used to remove the excess portions 128 of the forged impeller 100.

Solid line 110 now appears in two places still representing the border between areas of tensile stress 104, 106, 108 and areas of compressive stress 112, 113, 127, 129. Line 110 extends radially into the part to a relatively large depth indicating that cold expansion of the central aperture 102 has affected residual stresses throughout the entire part. The depth of the compressive residual stress areas 112, 113, 127 and 129, extending in the radial direction from the bore surface 101 into the part, can be, but is not limited to, 0.5 inches (1.3 cm). The cold expansion of the central aperture 102 effects areas outside of the local area 124. The residual stress redistribution achieved by cold expansion of the central aperture has resulted in tensile areas 104, 106, 108, 125 positioned radially between the inner solid 110 line near the central aperture 102 and the outer solid 110 line towards the outer diameter of the forged impeller. In comparison to FIG. 2, the solid line 110 no longer intersects the bore surface 101, indicating that the cold expansion process has affected the residual stresses throughout the entire forged impeller 100. The areas of tensile stress 104, 106, 108, 125 have moved away from the central aperture 102 to such a degree that the border 110 between areas of tensile stress 104, 106, 108, 125 and areas of compressive stress 112, 113, 127, 129 now appears in two locations.

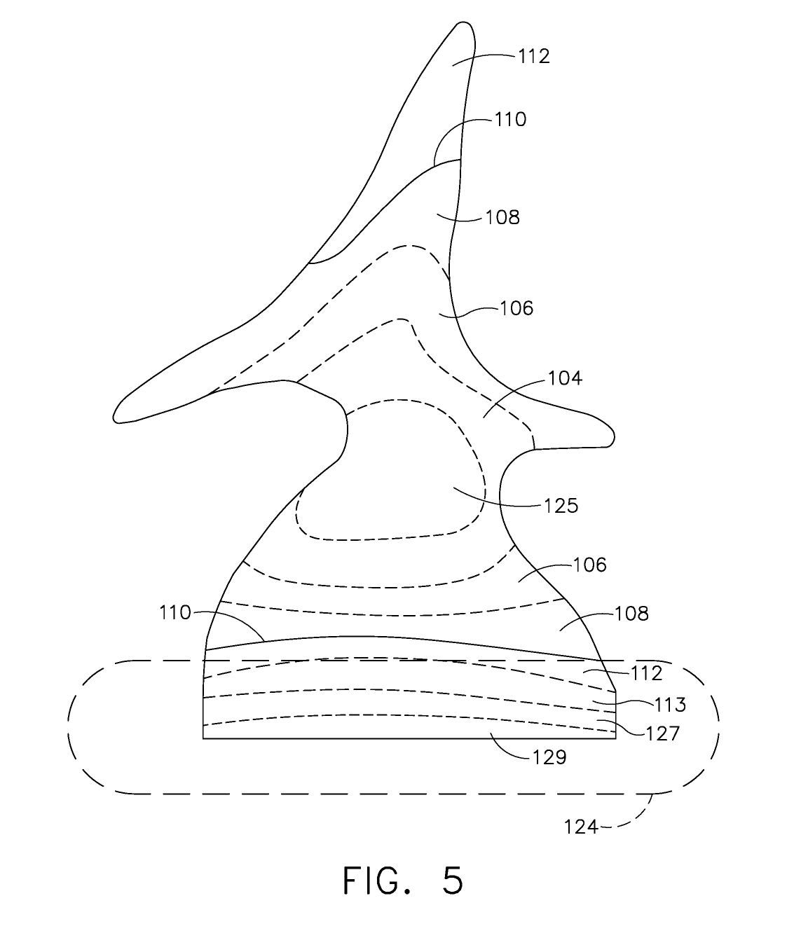

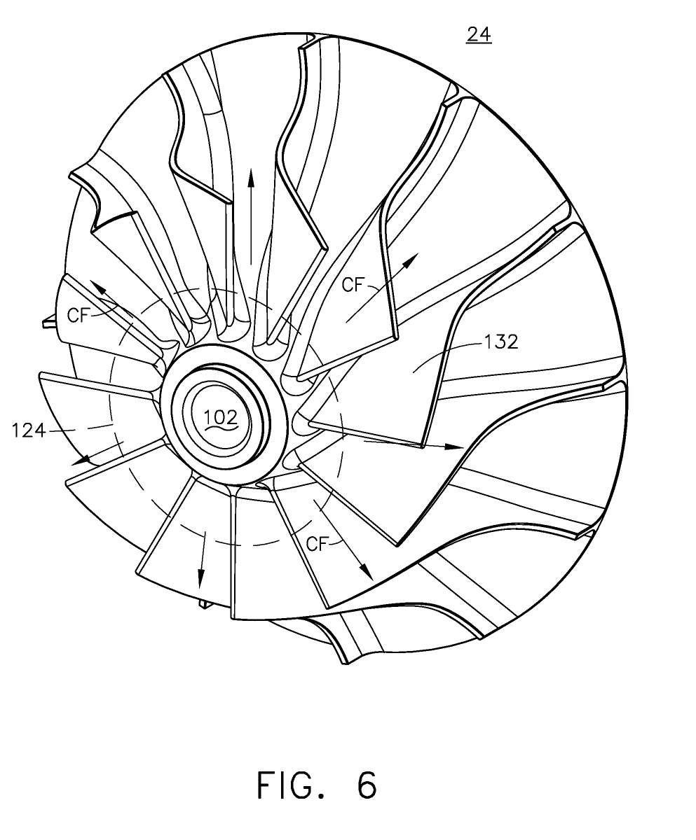

FIG. 5 is a cross-section of the final impeller 24. Only areas of compressive stress 112, 113, 127, 129 remain in the local area 124 proximate the bore surface 101. In the final impeller 24, an area of relatively high compressive stress 129 at least partially circumscribes the central aperture 102. Changing tensile stress areas 104, 106, 108, 125 to compressive stress areas 112, 113, 127, 129 includes distributing the compressive stress areas 112, 113, 127, 129 within the local area proximate the central aperture 102 to a radial extent, for example, but not limited to, of 0.5 inches (1.3 cm). It should be noted that the local area 124 no longer includes any tensile stress areas 104, 106, 108, 125. The areas of residual stress 104, 106, 108, 112, 113, 125, 127, 129 in the impeller 24 have been globally redistributed throughout the impeller 24 such that a net hoop stress change of zero has occurred within the impeller 24.

FIG. 6 is a perspective view of the exemplary final impeller 24 including impeller vanes 132. During operation the impeller 24 rotates at high speeds. Over a lifetime of the impeller 24 repeated centrifugal forces (CF) can create areas of higher tensile stress proximate the central aperture 102 when compared to the initial stress of the local area 124 proximate the central aperture 102. Replacing tensile stress with compressive stress in the local area 124 using the cold expansion as described herein prior to operation provides a fatigue life improvement (low cycle fatigue and fracture mechanics) to the impeller. In comparison tests performed between disks having undergone the split sleeve cold expansion treatment and no cold expansion treatment, a redistribution of tensile stress using split sleeve cold expansion significantly increased the lifetime of the impeller bore.

The process described herein can improve the low cycle fatigue capability of the central aperture of an engine component, and when applied to a rotating disk also improves dimensional stability for disk alloys with residual forging stresses that would otherwise lead to permanent deformation after operation. The process can be applied to any engine component with a central aperture in order to achieve improved fatigue capability, dimensional control, or both. In addition, the process described herein offers advantages relative to the prior art for improving rotating disk bore fatigue life and reducing rotating disk plastic deformation.

Additionally along with relaxing the tensile residual stresses in the local area from the forging heat treat process, the cold expansion also improves the dimensional stability, or radial growth, of the part during engine operation. A pre-stress treatment is required to meet both the bore fatigue lifetime requirements along with permanent growth requirements for the impeller (dimension stability i.e. radial growth resulting from engine operation). The cold expansion treatment achieves both of these requirements and improves upon it when compared to known pre-spin treatments. Pre-spin processing is typically more costly than applying the split sleeve cold expansion as described herein.

Additionally, while pre-spin treatments reduce tensile stress from areas surrounding the aperture, a pre-spin treatment typically results in residual tensile stresses in undesirable areas of the impeller including on radially outer portions of the impeller. Negative impacts from poorly redistributing the tensile stress occur with pre-spin treatments and are reduced using the split sleeve cold expansion described herein.

Finally, utilizing one manufacturing process rather than two to achieve both lifetime benefit and dimensional stability occurs with cold expansion. Testing regarding the low cycle fatigue life benefit have been demonstrated. Improvements regarding dimensional stability have been predicted using elastic/plastic finite element analysis.

It should be appreciated that application of the disclosed design is not limited to turboshaft and turboprop engines, but is applicable to turbine engines with fan and booster sections as well.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for redistributing a residual stress about a central aperture of a pre-machined engine component, the method comprising changing tensile stress to compressive stress in the pre-machined engine component by applying cold expansion to the central aperture of the pre-machined engine component.

2. The method of claim 1 further including changing tensile stress to compressive stress at an area local to the central aperture.

3. The method of claim 2 wherein the changing tensile stress to compressive stress includes distributing the compressive stress within an area local to the central aperture.

4. The method of claim 3 wherein the area local to the central aperture has a radial extent of 0.5 inches (1.3 cm).

5. The method of claim 1 further including distributing the tensile stress outside of an area local to the central aperture.

6. The method of claim 1 further including globally redistributing the residual stress in the engine component.

7. The method of claim 6 wherein globally redistributing the residual stress in the engine component results in a zero net hoop stress change in the component.

8. The method of claim 1 wherein the redistributing the residual stress occurs in a forged engine component.

9. The method of claim 1 further including increasing the final engine component fatigue life capability and providing improved dimensional stability.

10. The method of claim 1 further including pre-fitting a tapered mandrel with a lubricated split sleeve.

11. The method of claim 10 further including pulling the tapered mandrel through the central aperture.

12. The method of claim 11 wherein the pulling the tapered mandrel through the central aperture includes pulling the tapered mandrel through an aperture with a diameter of less than 3 inches (8 cm).

13. The method of claim 11 wherein the pulling the tapered mandrel through the central aperture includes pulling the tapered mandrel through an aperture with a diameter of less than 2 inches (5 cm).

14. A method for redistributing an area of residual stress in a forged rotating disk prior to completing a final machining, the method comprising changing tensile stress to compressive stress in the forged impeller by applying cold expansion to the center of the forged rotating disk.

15. The method of claim 14 further including changing tensile stress to compressive stress at an area local to the center of the forged rotating disk.

16. The method of claim 15 wherein the changing tensile stress to compressive stress includes distributing the compressive stress within the area local to the center of the forged rotating disk to a radial extent of 0.5 inches (1.3 cm).

17. The method of claim 14 further including distributing the tensile stress outside of the area an area local to the center of the forged rotating disk.

18. The method of claim 14 further including globally redistributing the residual stress in the forged rotating disk.

19. The method of claim 18 wherein the globally redistributing the residual stress in the forged rotating disk results in a net hoop stress of zero.

20. The method of claim 14 wherein the redistributing a residual stress occurs in a forged impeller.

21. The method of claim 14 further including increasing the forged rotating disk fatigue life capability and providing improved dimensional stability.

22. The method of claim 14 further including applying split sleeve cold expansion to the center of the forged rotating disk.

23. The method of claim 14 further including pre-fitting a tapered mandrel with a lubricated split sleeve.

24. The method of claim 23 further including pulling the tapered mandrel through the center.

25. The method of claim 24 wherein the pulling the tapered mandrel through the center includes pulling the tapered mandrel through an aperture with a diameter of less than 8 cm (3.1 in).

26. The method of claim 24 wherein the pulling the tapered mandrel through the center includes pulling the tapered mandrel through an aperture with a diameter of less than 5 cm (2 in).
